(19) United States
(12) Patent Application Publication
(10) Pub. No.: US 2022/0188837 A1
(43) Pub. Date: Jun. 16, 2022

(54) SYSTEMS AND METHODS FOR MULTI-AGENT BASED FRAUD DETECTION

(71) Applicant: JPMORGAN CHASE BANK, N.A., New York, NY (US)

(72) Inventors: Samuel Ayalew ASSEFA, Hoboken, NJ (US); Suchetha SIDDAGANGAPPA, Brooklyn, NY (US); Danial DERVOVIC, London (GB); Prashant P. REDDY, Madison, NJ (US); Maria Manuela VELOSO, Pittsburgh, PA (US)

(21) Appl. No.: 17/118,209

(22) Filed: Dec. 10, 2020

(51) Int. Cl. G06Q 30/00; G06N 20/00

(52) U.S. Cl. CPC G06Q 30/0185; G06N 20/00

(57) ABSTRACT

Systems and methods for multi-agent based fraud detection are disclosed. A method may include: providing a generator configuration file comprising a plurality of transaction behaviors and a number or proportion of generator agents to act in accordance with each transaction behavior; providing a detector configuration file comprising a detector parameter for a plurality of detector agents to use; generating a first set of test data using the generator agents based on the transaction behavior, wherein the first set of generated test data may include a first set of generated test transactions, and each generated test transactions may include a fraud indicator based on the transaction behavior; training a plurality of detector agents using the first set of generated test data and the detector configuration file, wherein each detector agent outputs a first trained model object; and outputting a first trained detection model based on the first trained model objects.

### BACKGROUND OF THE INVENTION

### 1. Field of the Invention

Embodiments relate generally to systems and methods for multi-agent based fraud detection.

### 2. Description of the Related Art

Wholesale and retail payment providers implement fraud detection algorithms in an attempt to prevent fraudulent transactions from occurring. A common problem with current systems is that fraud is not a common occurrence; thus, real data is sparse, noisy, and unbalanced, and has limited usefulness in training effective decision models.

### SUMMARY OF THE INVENTION

Systems and methods for multi-agent based fraud detection are disclosed. According to one embodiment, in an information processing apparatus comprising at least one computer processor, a method for multi-agent based fraud detection may include: (1) providing a generator configuration file comprising a plurality of transaction behaviors and a number or proportion of generator agents to act in accordance with each transaction behavior; (2) providing a detector configuration file comprising a detector parameter for a plurality of detector agents to use; (3) generating a first set of test data using the generator agents based on the transaction behavior, wherein the first set of generated test data may include a first set of generated test transactions, and each generated test transactions may include a fraud indicator based on the transaction behavior; (4) training a plurality of detector agents using the first set of generated test data and the detector configuration file, wherein each detector agent outputs a first trained model object; and (5) outputting a first trained detection model based on the first trained model objects.

In one embodiment, the plurality of behaviors may include a fraudulent behavior and a non-fraudulent behavior.

In one embodiment, the first trained detection model may be generated using a voting mechanism to select the first trained model object to use. The voting mechanism may include majority voting or weighted averaging.

In one embodiment, the method may further include: increasing a time step; generating a second set of test data using the generator agents based on the transaction behavior, wherein the second set of generated test data may include a second set of generated test transactions; training the plurality of detector agents using the second set of generated test data and the detector configuration file, wherein each detector agent outputs a second trained model object; and updating the trained detection model based on the second trained model objects.

In one embodiment the generator configuration file may include a stopping criteria that may be based on a number of time steps, and the process further may include: increasing the time step; and repeating the generating, training and updating step until the stopping criteria may be met. In another embodiment, the stopping criteria may be based on a number of generated test transactions, and the process further may include: increasing the time step; and repeating the generating, training and updating step until the stopping criteria may be met.

In one embodiment the detector parameter may include a logistic regression algorithm or a boosted tree learning algorithm.

In one embodiment, the method may further include deploying the first trained detection model to the detector agents; providing the detector agents with live transaction data, wherein the detector agents output a prediction as to whether each transaction may be fraud or not fraud; and outputting the prediction.

In one embodiment, the method may further include training the detector agents with the prediction and the live data.

According to another embodiment, a system for multi-agent based fraud detection may include a generator module including a plurality of generator agents; a generator configuration file comprising a plurality of transaction behaviors and a number or proportion of generator agents to act in accordance with each transaction behavior; and generated test data storage; a detector module that may include a plurality of detector agents; a detector configuration file comprising a detector parameter for the detector agents to use; and a combiner that combines outputs of the plurality of detector agents; and a control module including a controller that controls the generator module and the detector module. The control module may control the generator agents to generate a first set of test data based on the transaction behavior, wherein the first set of generated test data may include a first set of generated test transactions, and each generated test transactions may include a fraud indicator based on the transaction behavior; may control the detector agents using the first set of generated test data and the detector configuration file, wherein each detector agent outputs a first trained model object; and may control the combiner to combine the first trained model objects and output a first trained detection model.

In one embodiment, the plurality of behaviors may include a fraudulent behavior and a non-fraudulent behavior.

In one embodiment, the first trained detection model may be generated using a voting mechanism to select the first trained model object to use. The voting mechanism may include majority voting or weighted averaging.

In one embodiment, the control module may increase a time step and may (i) control the generator agents to generate a second set of test data using the generator agents based on the transaction behavior, wherein the second set of generated test data may include a second set of generated test transactions; (ii) may control the training agents using the second set of generated test data and the detector configuration file, wherein each detector agent outputs a second trained model object; and (iii) may control the combiner to update the trained detection model based on the second trained model objects.

In one embodiment, the generator configuration file may include a stopping criteria based on a number of time steps, and the control module may increase the time step and repeat the generating, training and updating step until the stopping criteria may be met.

In one embodiment, the generator configuration file may include a stopping criteria based on a number of generated test transactions, and the process further may increase the time step and repeat the generating, training and updating step until the stopping criteria may be met.

In one embodiment, the detector parameter may include a logistic regression algorithm or a boosted tree learning algorithm.

In one embodiment, the control module may further deploy the first trained detection model to the detector agents. The detector agents may receive live transaction data and output a prediction as to whether each transaction may be fraud or not fraud.

In one embodiment, the control module may use the prediction to train the detector agents.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for multi-agent based fraud detection according to one embodiment;

FIG. 2 depicts a method for multi-agent based fraud detection according to one embodiment;

FIG. 3 depicts an example test data set according to one embodiment;

FIGS. 4A and 4B depicts exemplary configuration files according to one embodiment;

FIG. 5 depicts an example graphical output of payments a generation and real-time fraud detection simulation according to one embodiment; and

FIGS. 6A-6D depict exemplary outputs of payments generation and real-time fraud detection with voting simulation according to embodiments.

### DETAILED DESCRIPTION OF PREFERRED EMBODIMENTS

Embodiments relate generally to systems and methods for multi-agent based fraud detection.

For example, a simulation environment allows for the generation of data with various known fraud/anomaly patterns, which may then be used to train a multi-agent set of detectors that contribute to a fraud/no fraud final decision. In embodiments, the generation and detection components may be decoupled to ensure their independent evolution. The generation components may change their strategy based on how the detector components react, and vice-versa. This may be based, for example, on machine learning, artificial intelligence, rules-based engines, etc.

Embodiments may use client profiles in making decisions on whether to identify a transaction as potentially fraudulent. For example, compromised accounts are more likely to be highly active (e.g., have more payments, send to more beneficiary banks and accounts, etc.) than secure accounts. Adding client profile features related to origin/destination country increases recall (i.e., catches more fraud) but reduces precision (i.e., generates more false alerts).

Adding client profile features related to the client's historical patterns, and how those patterns relate to the current payment, increases both precision and recall.

Embodiments may automate rule analysis and optimization leveraging machine learning to reduce false positives. For example, machine learning modules may be trained to identify and reduce false positive targets.

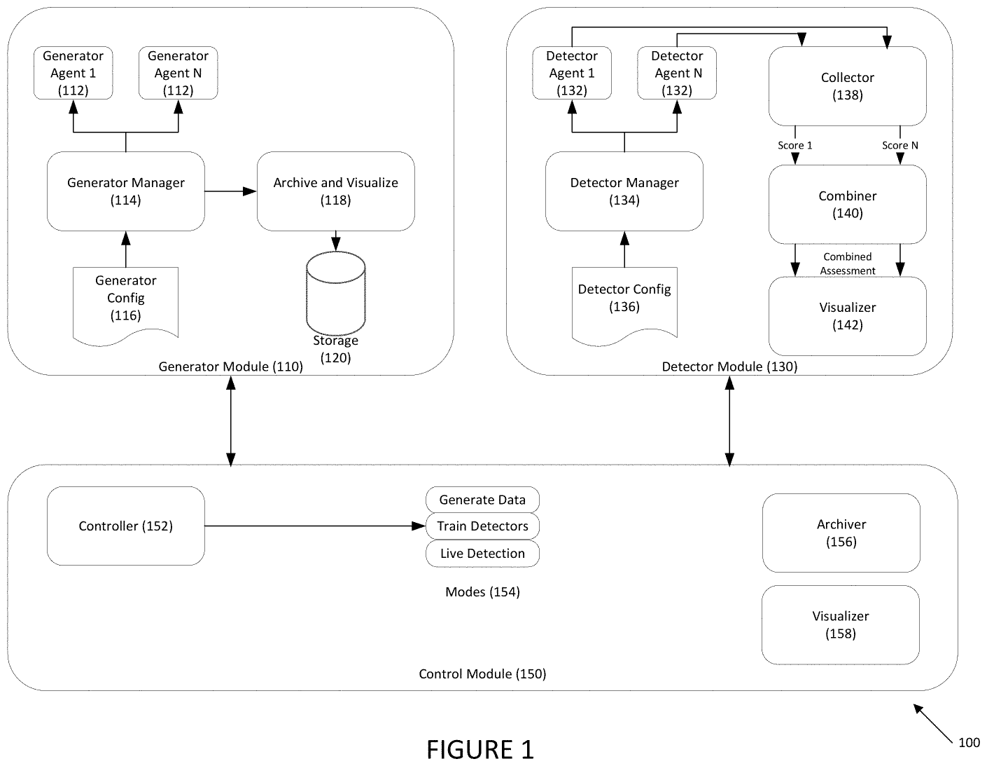

Referring to FIG. 1, a system for multi-agent based fraud detection, reduction in false positives in fraud detection and rules threshold optimization is disclosed according to an embodiment. System 100 may include generator module 110, detector module 130, and control module 150. Each module may operate on one or more electronic devices (e.g., computers, workstations, servers, in the cloud, etc.).

Generator module 110 may include one or more generator agents 112 (e.g., generator agent 1, . . . generator agent n), generator manager 114, generator configuration (config) file 116, archive and visualize module 118, and storage 120.

Detector module 130 may include one or more detector agents 132 (e.g., detector agent 1, . . . detector agent n), detector manager 134, detector configuration (config) file 136, collector 138, combiner module 140, and visualizer 142.

Control module 150 may include controller 150 which may operate in one of three modes 154: generate data mode, train detector mode, and live detector mode.

Archiver 156 may store archived data, and visualizer 158 may visualize data.

Generator agents 112 may perform various roles, such as a sender (e.g., a client) and a receiver (e.g., a beneficiary) during the simulation process. Generator agents 112 may take on the role of client when they initiate a payment and they take on the role of a beneficiary when they receive a payment. When generator agent 112 has taken the role of a client (e.g., a client agent), there are at least two types of behaviors they can exhibit: good and bad. An example a bad behavior is an unusually high amount, unusual or suspicious destination country when compared with historical patterns. These behaviors could further be subdivided into sub-categories.

In one embodiment, payments generated by good behaviors are considered to be non-fraudulent payments, whereas payments generated by bad behaviors are considered to be fraudulent payments. Different types of good and bad behaviors may be defined and may be specified in generator config file 116 file that may be processed and orchestrated by the generator manager 114. Generator agents 112 may be instantiated with some attributes (e.g., balance, country and sector) following a distribution specified in the generator config file 116. At each time step, a subset of agents may be activated and once activated, they choose a beneficiary according to their behavior type and will make a payment.

The time step is a representation of discrete time unit values. for example, the time unit values may be an arbitrary measure of time (e.g., a minute, an hour, etc.). In embodiments, test data is that may or may not have fraudulent activity is generated, and then the time step is advanced by one unit. The test data generated at each time step may be structurally similar (e.g., it has the same column names), but will have different content as that is determined by a stochastic process. The difference may include, for example, the number of senders and/or recipients, the fraud ratio, the countries involved, etc.

At the end of each time step, generator manager 114 may check to see if a specified stopping criteria is met. If so, the generation stops. Otherwise, the simulation clock moves forward and the agents are activated. An example stopping criterion is to stop the generation after reaching the a certain number of time steps specified by the user, the generation of a certain number of test transactions, etc.

The data generated by generator module 110 may be stored in various formats (e.g., a csv file) by storage 120.

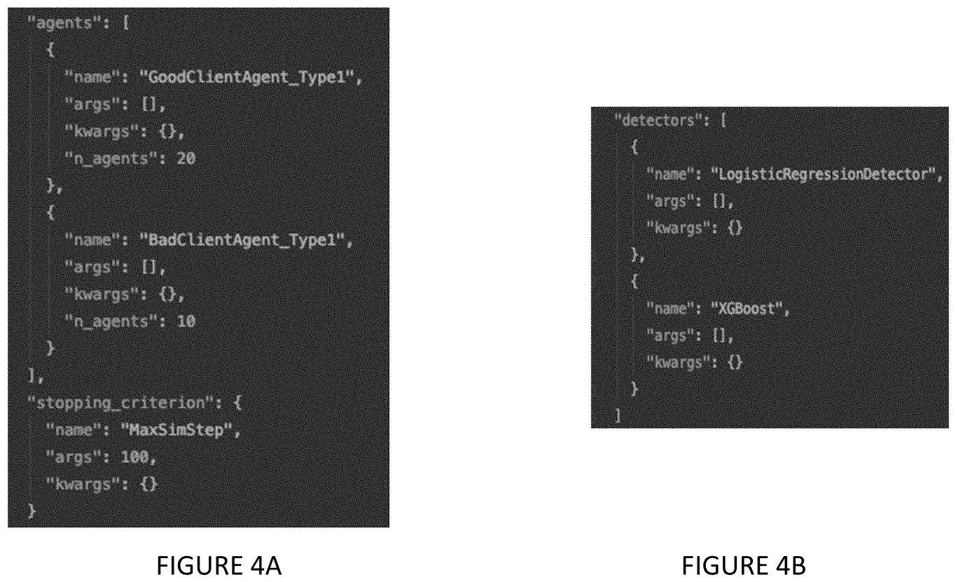

Generator config file 116 may configure parameters and options that may be used to run generator agents 112. Example parameters may include a stopping criteria, a list of various types of behaviors, a number or proportion of agents to be instantiated to follow these behaviors, etc. An example definition is shown in FIG. 4A.

Archive and visualize module 118 may serve as a component to analyze the generated data using, for example, exploratory and descriptive analytics methods and may offer visualizations, such as statistical distributions, geographical visualizations, etc.

Detector module 130 may include detector agents 132, detector manager 134, defector config file 136, collector 138, combiner module 140, and visualizer 142. Detector agents 132 may be “experts” that have an underlying expert-knowledge (e.g., via a machine learning training, rules engines, or any other approach to embody decision making abilities). Detector manager 134 may orchestrate the operations of detector agents 132.

Detector config file 136 may comprise parameters used to run the detector agents 132. An example of such configuration is how parameters for detector agent 132 use a logistic regression or a boosted tree learning algorithm, such as those described in FIG. 4B. Other algorithms may be used as is necessary and/or desired.

In one embodiment, each detector agent 132 may have a separate set of parameters. For example, detector 132₁ may use a logical regression algorithm, while detector 132₂ may use a boosted tree learning algorithm.

Collector 138 may receive the output of multiple detector agents 132 for processing by combiner module 140, which may implement a voting mechanism, such as majority voting, to combine votes received from the various detector agents 132 into an aggregate decision.

In another embodiment, combiner module 140 may use weighted averaging to combine the outputs of detector agents 132 into a trained model.

Control module 150 may include controller 152, which may act as an orchestrator for generator module 110 and detector module 130. In embodiments, the controller may run in one of three modes 154—generate data mode, train detectors mode, and live detection mode—as the components are decoupled.

Generate data mode runs generator module 110 and stores the result in storage 120.

Train detectors mode trains detector agents 132 using data generated in generate data mode, as well as historical data. Examples include machine learning based classifiers. The data used to train detector agents 132 may be retrieved from storage 120.

Live detection mode may involve the generation of data for each time step and before advancing the time step. Detector agents 132 may predict the outcome of these payments after which the timer is advanced and the process may be repeated.

For example, at each new timestep, test data may be generated according to parameters in generator config file 116. For example, generator module 110 may generate a fraudulent transaction with a probability of 1%, which will result in different datasets at each step. This improves the robustness of detector agents 132.

In one embodiment, the results of live detection may be used to train detector agents 132.

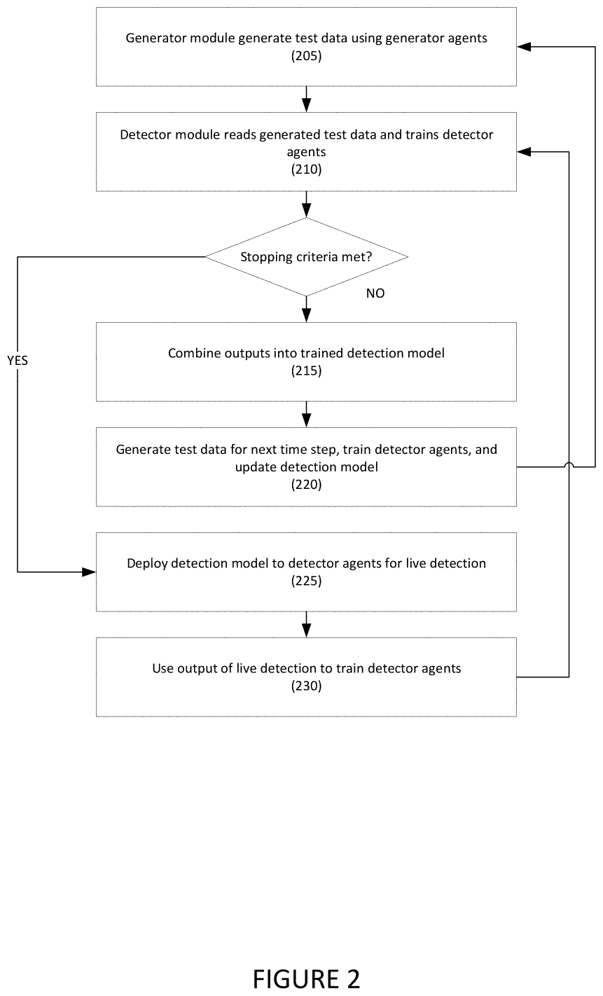

Referring to FIG. 2, a method for multi-agent based fraud detection, reduction in false positives in fraud detection and rules threshold optimization is disclosed according to an embodiment.

In step 205, the generator module may be run to generate test data. For example, using a generator config file, the generator manager may control generator agents to generate test data. The generator config file may identify a plurality of behavior types, such as good or bad, fraudulent or non-fraudulent, etc. and a number, a proportion, etc. of generator agents that are to generate test data based on each type of behavior. For example, if there are 10 generator agents, one may be instructed to act according to the fraudulent behavior on some or all of the test transactions that it generates.

The generated test data may include a plurality of test transactions, and each transaction may include an indication as to whether the test transaction is fraudulent or not. The generalized test data may then be stored in, for example, generator module storage. This may be performed under the control of the controller in the control module, which may use the generator config file to establish the initial parameters.

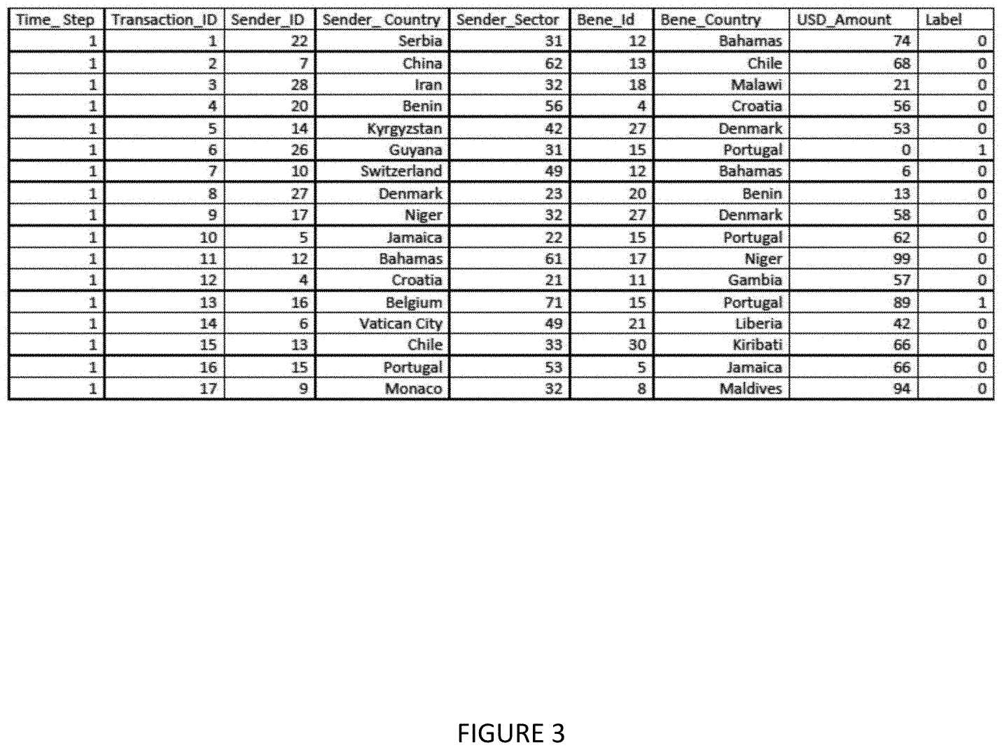

An example set of generated test data is provided in FIG. 3. The generated data indicates which transactions are fraudulent based on the generator agent behaviors. The column “Label” in FIG. 3 indicates whether a transaction is fraudulent (1) or not (0).

In step 210, detector agents may be trained. For example, a detector module may read the generated test data from the generator module storage. Using a detector manager and a detector config file, the detector agents may be trained to identify fraudulent and/or non-fraudulent transactions using the generated test data. For example, the detector agents may be trained using the generated test data and using a parameter configuration for each detector via the detector config files. The parameters may identify an algorithm for each detector agent to use.

In one embodiment, the detector agents may generate a model, such as a machine learning module, a rules-based model, etc. The output of each detector agent is a trained model object, which may be stored in various formats, such as Predictive Model Markup Language (PMML). The stored models may be used to test new samples using, for example, collector and combiner modules.

In step 215, the trained model objects from the detector agents may be collected (e.g., by a collector) and combined (e.g., by a combiner) into a trained detection model. For example, the combiner may use a voting mechanism, such as majority vote, or weighted averaging, etc. to combine the trained model objects into the trained detection model. Other techniques may be used as is necessary and/or desired.

In step 220, for each time step until a stopping criteria is met, the generator module may be run to generate additional test data for one time step, and then the detector module may be run to predict fraudulent transactions. For example, the stopping criteria may be specified in the generator config file and may instruct the generator module when to stop the generation and/or the training steps. A simulation duration of one day or any suitable time period, a transaction count (e.g., 100 transactions) are examples of a stopping criteria. Any suitable stopping criteria may be used as is necessary and/or desired.

An example agent setup and detector setup is illustrated in FIGS. 4A and 4B, respectively. FIG. 4A depicts an example of a generator config file, and FIG. 4B depicts an example of a detector config file.

In step 225, the trained detection model may be deployed to detect fraud with live data.

In step 230, the output of the live detection may be used as training data to further train the detector agents.

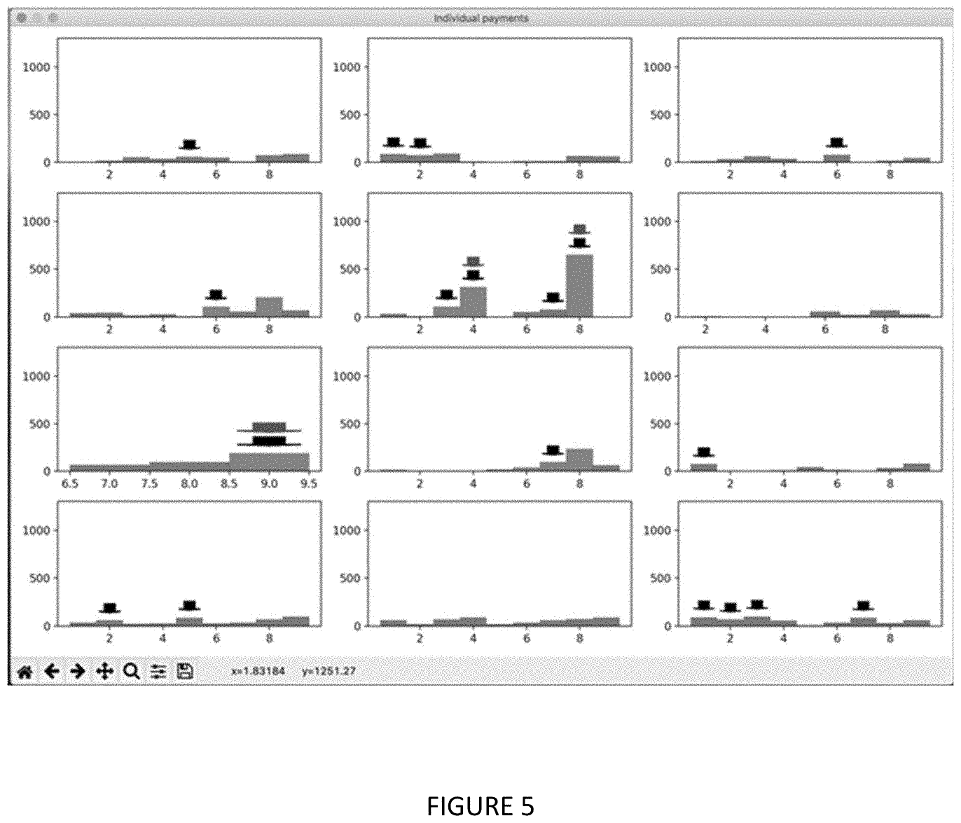

An example of payments generation and real-time fraud detection is provided in FIG. 5. In this example, a simulation was run on transaction data from 12 client accounts using two detectors, and each subplot represents client accounts with the multiple detectors run on data from each client. The x-axis represents the time step and the y-axis represents the dollar amount of each transaction. In one embodiment, the bars may be colored to identify fraud or no fraud. Arrows indicate predictions made by each of two different detector agents. For some time steps, the two detectors agree, indicated by the absence of arrows above a time step, or the presence of two arrows above each time step. For other time steps, the detectors do not agree, indicated by only one arrow above a time step. Thus, various voting mechanisms may be applied to determine whether the prediction is fraud or no-fraud.

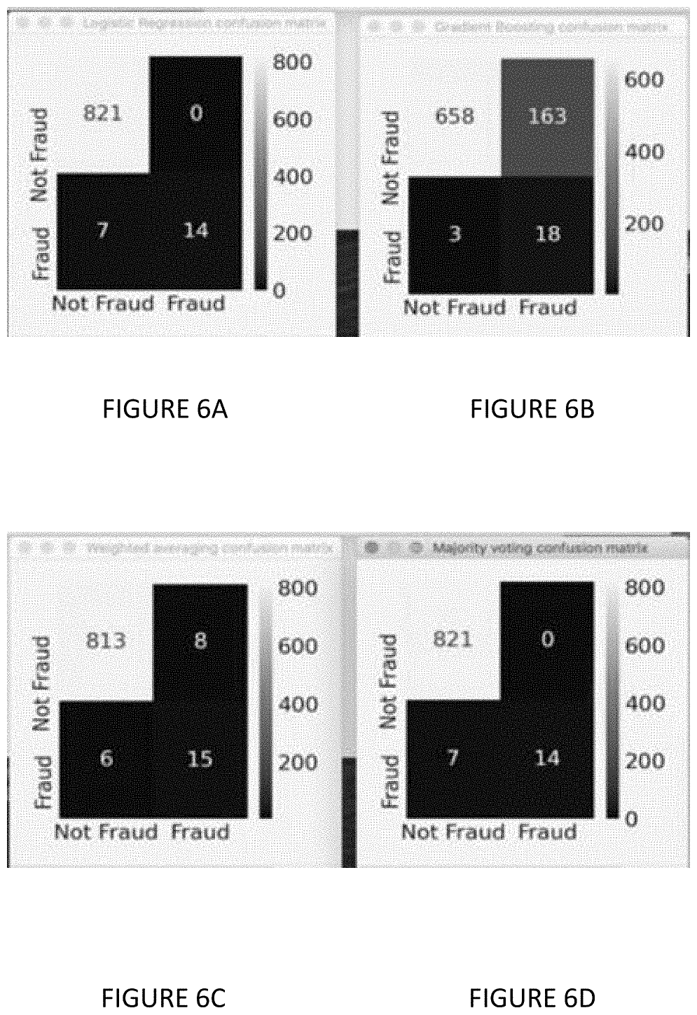

For example, FIGS. 6A-6D depict exemplary outputs of payments generation and real-time fraud detection with voting simulation. FIGS. 6A and 6B depict a confusion matrix from the output of two detector agents using logistic regression and gradient boosting algorithms, respectively. Based on the confusion matrix, the two detectors have different performances, potentially due to inherent differences in the algorithms and the complexity of the data. To address this challenge, various types of voting schemes are used.

FIG. 6C depicts a confusion matrix using a weighted averaging voting scheme, and FIG. 6D depicts a confusion matrix using a majority vote voting scheme. The voting scheme to be used is configured using the config files in a similar way to the detector agent configurations.

The confusion matrix may be used to select the appropriate parameters for the detector agents and the appropriate voting scheme.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for multi-agent based fraud detection, comprising:
in an information processing apparatus comprising at least one computer processor:
providing a generator configuration file comprising a plurality of transaction behaviors and a number or proportion of generator agents to act in accordance with each transaction behavior;
providing a detector configuration file comprising a detector parameter for a plurality of detector agents to use;
generating a first set of test data using the generator agents based on the transaction behavior, wherein the first set of generated test data comprises a first set of generated test transactions, and each generated test transactions comprises a fraud indicator based on the transaction behavior;
training a plurality of detector agents using the first set of generated test data and the detector configuration file, wherein each detector agent outputs a first trained model object; and
outputting a first trained detection model based on the first trained model objects.

2. The method of claim 1, wherein the plurality of behaviors comprise a fraudulent behavior and a non-fraudulent behavior.

3. The method of claim 1, wherein the first trained detection model is generated using a voting mechanism to select the first trained model object to use.

4. The method of claim 3, wherein the voting mechanism comprises majority voting or weighted averaging.

5. The method of claim 1, further comprising:
increasing a time step;
generating a second set of test data using the generator agents based on the transaction behavior, wherein the second set of generated test data comprises a second set of generated test transactions;
training the plurality of detector agents using the second set of generated test data and the detector configuration file, wherein each detector agent outputs a second trained model object; and
updating the trained detection model based on the second trained model objects.

6. The method of claim 5, wherein the generator configuration file further comprises a stopping criteria based on a number of time steps, and the process further comprises:
increasing the time step; and
repeating the generating, training and updating step until the stopping criteria is met.

7. The method of claim 5, wherein the generator configuration file further comprises a stopping criteria based on a number of generated test transactions, and the process further comprises:
increasing the time step; and
repeating the generating, training and updating step until the stopping criteria is met.

8. The method of claim 1, wherein the detector parameter comprises a logistic regression algorithm or a boosted tree learning algorithm.

9. The method of claim 1, further comprising:
deploying the first trained detection model to the detector agents;
providing the detector agents with live transaction data, wherein the detector agents output a prediction as to whether each transaction is fraud or not fraud; and
outputting the prediction.

10. The method of claim 9, further comprising:
training the detector agents with the prediction and the live data.

11. A system for multi-agent based fraud detection, comprising:
a generator module comprising:
a plurality of generator agents;
a generator configuration file comprising a plurality of transaction behaviors and a number or proportion of generator agents to act in accordance with each transaction behavior; and
generated test data storage;
a detector module comprising:
a plurality of detector agents;
a detector configuration file comprising a detector parameter for the detector agents to use; and
a combiner that combines outputs of the plurality of detector agents; and
a control module comprising a controller that controls the generator module and the detector module;
wherein:
the control module controls the generator agents to generate a first set of test data based on the transaction behavior, wherein the first set of generated test data comprises a first set of generated test transactions, and each generated test transactions comprises a fraud indicator based on the transaction behavior;
the control module controls the detector agents using the first set of generated test data and the detector configuration file, wherein each detector agent outputs a first trained model object; and
the control module controls the combiner to combine the first trained model objects and output a first trained detection model.

12. The system of claim 11, wherein the plurality of behaviors comprise a fraudulent behavior and a non-fraudulent behavior.

13. The system of claim 11, wherein the first trained detection model is generated using a voting mechanism to select the first trained model objects to use.

14. The system of claim 13, wherein the voting mechanism comprises majority voting or weighted averaging.

15. The system of claim 11, wherein:
the control module increases a time step;
the control module controls the generator agents to generate a second set of test data using the generator agents based on the transaction behavior, wherein the second set of generated test data comprises a second set of generated test transactions;
the control module controls the training agents using the second set of generated test data and the detector configuration file, wherein each detector agent outputs a second trained model object; and
the control module controls the combiner to update the trained detection model based on the second trained model objects.

16. The system of claim 15, wherein the generator configuration file further comprises a stopping criteria based on a number of time steps, and wherein:
the control module increases the time step; and
the control module repeats the generating, training and updating step until the stopping criteria is met.

17. The system of claim 15, wherein the generator configuration file further comprises a stopping criteria based on a number of generated test transactions, and:
the control module increases the time step; and
the control module repeats the generating, training and updating step until the stopping criteria is met.

18. The system of claim 14, wherein the detector parameter comprises a logistic regression algorithm or a boosted tree learning algorithm.

19. The system of claim 11, wherein the control module deploys the first trained detection model to the detector agents; and
the detector agents receive live transaction data and output a prediction as to whether each transaction may be fraud or not fraud.

20. The system of claim 19, further comprising:
using the prediction to train the detector agents.
